(19) United States
(12) Patent Application Publication
(10) Pub. No.: US 2025/0179678 A1
(43) Pub. Date: Jun. 5, 2025

(54) CORROSION PROCESSING FOR ENHANCED BIOSENSING ON MG ALLOYS

(71) Applicant: University of Utah Research Foundation, Salt Lake City, UT (US)

(72) Inventors: Shuaihang PAN, Salt Lake City, UT (US); Yunshan WANG, Salt Lake City, UT (US); Bo ZHAO, Salt Lake City, UT (US); Mohammad MOHAMMADI, Salt Lake City, UT (US)

(21) Appl. No.: 18/965,132

(22) Filed: Dec. 2, 2024

Related U.S. Application Data
(60) Provisional application No. 63/605,496, filed on Dec. 2, 2023.

(51) Int. Cl. C25D 11/30; G01N 21/64

(52) U.S. Cl. CPC C25D 11/30; G01N 21/645

(57) ABSTRACT

A sensor can include a functional surface that includes a magnesium alloy. The function surface can have a fluorescence enhancing microstructure formed by electrochemical corrosion of the magnesium alloy at the functional surface. A method of forming the sensor can include providing a precursor substrate having a magnesium alloy surface, and electrochemically treating the magnesium alloy surface in the presence of an electrolyte to electrochemically corrode the surface.

### CROSS REFERENCE TO RELATED APPLICATIONS

This application claims priority to U.S. Provisional Patent Application No. 63/605,496, filed Dec. 2, 2023, which is hereby incorporated herein by reference.

### STATEMENT REGARDING FEDERALLY SPONSORED

### Research or Development

None.

### NAMES OF THE PARTIES TO A JOINT RESEARCH AGREEMENT

Not applicable.

### INCORPORATION BY REFERENCE STATEMENT

Not applicable.

### BACKGROUND

Sensitive and specific detection of bio-molecules remain a challenge, despite their importance in biological, and medical research. Current technologies for the detection of biomolecules include high-performance liquid chromatography (HPLC), and bioanalytical assays. HPLC provides high sensitivity and selectivity; however, it requires substantial sample preparation, which can result in sample loss. HPLC also tends to involve expensive equipment and is not suitable for continuous monitoring of samples. Conventional bioanalytical assays such as enzyme-linked immunosorbent assay (ELISA), western blots, and surface plasmon resonances (SPR) require specific biorecognition elements such as antibodies or aptamers to capture target analytes selectively. Those assays suffer from poor specificity as antibodies or aptamers do not provide adequate specificity against similar biomolecules. ELISA involves dye labeling or enzymatic reaction, which is not suitable for continuous monitoring of samples. Spectroscopic methods such as Raman and infrared (IR) absorption can be very specific as they provide molecular fingerprints; however, the absorption cross-section is very small and thus does not provide adequate sensitivity. Electrochemical methods can provided continuous sensing of a sample, but the electrodes can suffer from biofouling and performance can degrade over time. For implantable sensors, the electrodes are usually removed after sensing tasks.

### SUMMARY

A sensor can include a functional surface that includes a magnesium alloy. The functional surface can have a fluorescence enhancing microstructure formed by electrochemical corrosion of the magnesium alloy at the functional surface. The fluorescence enhancing microstructure can include a surface roughness increased by the electrochemical corrosion compared to the functional surface prior to the electrochemical corrosion.

In certain examples, the surface roughness can be from 5 micrometers to 20 micrometers. The surface roughness can be Sa, defined as a mean difference in height from a mean plane of the functional surface. The surface roughness can be from 10% to 500% greater than a surface roughness of the functional surface prior to the electrochemical corrosion. In some examples, the magnesium alloy can also have high angle grain boundaries (HAGBs) having a misorientation greater than 15 degrees. The HAGBs can make up a number fraction of the total grain boundaries of the magnesium alloy that is from 50% to 100%. In further examples, the magnesium alloy can be at least 50% by volume magnesium. The magnesium alloy can include at least one of aluminum, lithium, calcium, zinc, silicon, silver, a rare earth metal, and a transition metal. In certain examples, the magnesium alloy can be selected from the group consisting of: Mg—Al, Mg—Li, Mg—Ca, Mg—Zn, Mg—Si, Mg—Ag, Mg—X wherein X is a transition metal or rare earth metal, and combinations thereof. In further examples, the magnesium alloy can be AZ31B, Mg—4Li—Ca, or Mg—Zr—Sr. The sensor can also include an energy responsive agent at least partially coated on the functional surface. The energy responsive agent can be a fluorescence responsive agent which is at least one of tryptophan, tyrosine, phenylalanine, a nanoplastic, or a microplastic. A fluorescence signal from the energy responsive agent can be increase by the fluorescence enhancing microstructure compared to the same energy responsive agent on an uncorroded surface of the magnesium alloy. In some examples, the fluorescence signal can be increased by 50% to 1,000%. In certain examples, the energy responsive agent can form a coating with a thickness less than the surface roughness change (i.e., less than 1 micrometer). The sensor can also include a sensor substrate and the magnesium alloy can be a coating supported by the sensor substrate. In alternative examples, the magnesium alloy can be self-supporting (e.g. sufficiently thick to retain shape) without a separate supporting substrate. In some examples, the sensor can degrade in vivo after a time period from 2 days to 6 months.

A method of forming a sensor can include providing a precursor substrate having a magnesium alloy surface. The magnesium alloy surface can be electrochemically treated in the presence of an electrolyte to electrochemically corrode the surface. For example, the electrolyte can be selected from the group consisting of NaCl (e.g. 3.5 wt %), simulated body fluids, KMnO₄, and alkaline solutions. In certain examples, the electrolyte can be an alkaline solution and the surface can further include a passivation film. In some examples, the electrochemical treatment can be performed for a sufficient time to increase a surface roughness of the magnesium alloy surface by 10% to 500%.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a schematic cross-sectional view of an example magnesium alloy before receiving an electrochemical corrosion treatment in accordance with the present technology.

FIG. 1B is a schematic cross-sectional view of the magnesium alloy after being treated with an electrochemical corrosion treatment in accordance with the present technology.

FIG. 2 is a schematic view of an example sensor in accordance with the present technology.

FIG. 3 is a schematic view of an example electrochemical corrosion process in accordance with the present technology.

FIG. 4A is an inverse pole figure showing grain morphology of an example magnesium alloy. The reference direction is out of the page.

FIG. 4B is a graph of distribution of grain boundary misorientation of the magnesium alloy.

FIG. 4C is a graph of grain size distribution of the magnesium alloy.

FIG. 4D is a back-scattered scanning electron microscope (SEM) image of the magnesium alloy surface.

FIG. 4E is a zoomed in view of the small boxed area in FIG. 4D.

FIGS. 4F and 4G show the EDS mapping of FIG. 4E.

FIG. 5A is a graph of the potentiodynamic polarization curve of the magnesium alloy and visual photographs of the alloy after the electrochemical corrosion treatment.

FIG. 5B is a graph of an impedance/phase frequency Bode plot of the magnesium alloy.

FIG. 5C is a graph of a Nyquist spectral curve of the magnesium alloy.

FIG. 6 is a graph of surface roughness of the magnesium alloy before the electrochemical corrosion treatment and after the treatment and after tryptophan coating.

FIG. 7A is a graph of fluorescence intensity of tryptophan on different substrates at different times.

FIG. 7B is a graph of integrate fluorescence density of the substrates at different times.

FIG. 8A shows photographs and surface height of another magnesium alloy substrate at week 0 and week 2 after being treated with an electrochemical corrosion treatment.

FIG. 8B is a graph of the surface roughness Sq of the magnesium alloy substrate at week 0 and week 2 after being treated with the electrochemical corrosion treatment.

FIGS. 9A-9C show electrochemical impedance scanning measurements of the magnesium alloy substrate at week 0 and week 2.

FIG. 10 is a graph of fluorescence intensity of several magnesium substrates coated with polystyrene nanobeads and a silicon substrate coated with polystyrene nanobeads.

FIG. 11A is a photograph of a magnesium alloy substrate coated with polystyrene nanobeads.

FIGS. 11B-11C are SEM images of the monolayer of polystyrene nanobeads on the magnesium alloy substrate.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “an alloy” includes reference to one or more of such materials and reference to “the electrode” refers to one or more of such electrodes.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Electrochemically Corroded Magnesium Alloy Sensors

The present technology involves sensor surfaces made from magnesium alloys. An electrochemical corrosion process can be used to treat these magnesium alloy surfaces, which can modify the microstructure of the surfaces. This process can increase the bio-sensing sensitivity and stability of the surfaces. This technology can utilize structural Mg alloys, which are widely available, thus providing low cost sensors. While many biosensors have previously had insufficient stability, the electrochemical corrosion process described herein can effectively stabilize the magnesium alloy surface for a prolonged time. Thus, the sensors can have a usable life sufficient for the duration of a variety of biosensing applications. The increased sensitivity exhibited by the sensors described herein stands out even when compared with similar magnesium alloy surfaces that have not been treated with the electrochemical corrosion process described herein.

The sensors described herein can be used for biosensing based on the fluorescence of biological molecules. Almost all biological molecules present some level of intrinsic fluorescence in the ultraviolet range of the spectrum. Proteins and peptides have native fluorescence mainly from the emission of three aromatic amino acid residues: tryptophan, tyrosine, and phenylalanine. Tryptophan dominates the native fluorescence of most proteins and peptides due to its relatively large quantum yield on the order of 0.1. As for nucleic acids, the native fluorescence comes from the sugar side chain but with a much smaller quantum yield on the order of 10⁻⁴. The absorption and emission spectrum and photophysical properties such as excited state lifetime and photobleaching rate are related to the molecular structures and the surrounding environment.

Examples of ultraviolet (UV) spectroscopy for biomolecule characterization include: UV absorption/emission spectroscopy for the quantitative determination of the concentration of the analytes, including proteins, nucleic acids, and small molecules; Monitoring of conformational changes of proteins using the UV emission and excited state lifetime of tryptophan residues; detection of ligand-protein interactions using emission intensities of tryptophan residues. All these applications of UV spectroscopy are beneficial in analyzing high concentration molecules in pure solution. However, these methods may not be suitable for detecting low concentration molecules in a heterogeneous sample.

Bio-sensing benefits from high signal strength in order to be precise and accurate. Magnesium (Mg) surfaces have photonic characteristics favorable to sense bio-molecules like tryptophan. However, the signal strength is weak with typical Mg surfaces. Magnesium is also highly reactive and therefore some magnesium bio-sensors can have insufficient stability in some environments, such as in vivo environments. However, the present technology utilizes an electrochemical corrosion treatment with a Mg alloy surface to make a functional surface for a sensor that can have surprisingly high signal strength. The electrochemical corrosion process also stabilizes the surface so that the sensor can be more stable and have a longer working life in various environments. Thus, the electrochemical surface processing serves dual roles, i.e., stabilizing the surface for prolonged bio-sensing duration, and enhance the bio-sensing signals by magnitudes. Applications can include plasmonic materials to achieve tunable degradation kinetics, i.e. for use in improving sensitivity and fluorescence yield in UV biosensors.

The light-matter interaction of plasmonic nanostructures with fluorophores has been studied in the visible range of the spectrum. The intensified local optical field improves the excitation rate by pumping more electrons to the excited state at a given time. The high local density of states near a metallic nanostructure increases the radiative rate and suppresses the photobleaching rate. In the visible range, plasmonic nanostructures can allow a two to three orders of magnitude increase in fluorescence yield. Plasmonic enhanced fluorescence can also improve the sensitivity of UV biosensors. In the sensors described herein, the electrochemical corrosion treatment can form a microstructure on the functional surface of the sensor which can allow plasmonic enhancement of fluorescence, increased Raman scattering signal, electrochemical sensor response, etc. for various targets, including biological molecules and other fluorescent materials.

In many examples described herein, the electrochemically corroded magnesium alloy surface is used to enhance the native fluorescence signal of tryptophan. However, these surfaces can also enhance the fluorescence signal of other biological molecules and non-biological fluorescent materials. Electrochemical and microstructural analyses have confirmed corrosion's role of surface morphology control. The corroded alloy surface exhibits significant fluorescence signal enhancement, highlighting its sensitive biosensing potential with a long-term stability.

Tryptophan stands out as the primary contributor to the intrinsic fluorescence of proteins and peptides. As explained above, this is due to tryptophan's high quantum yield compared to other aromatic amino acids and resultant efficiency in emitting fluorescence under ultraviolet (UV) irradiation. Additionally, Tryptophan's fluorescent properties can play a pivotal role in various biochemical and biophysical studies, providing valuable insights into protein structure and interaction. Using the UV light properties of biomolecules can lead to label-free bio-sensing. For these reasons, tryptophan is used in many examples described herein.

Magnesium (Mg) alloys can be utilized in the sensor surfaces described herein. Some particular examples include Mg—Ti alloys and Mg—Al alloys, although a variety of other Mg alloys can also be used. Mg is a common metallic element found in abundance in the earth's crust and the oceans and can have particularly useful properties for biomedical applications. For example, Mg is easy to process due to its relatively low hardness, and the Mg alloys are suitable for mass production due to their good castability. Furthermore, Mg has great potential in biomedical devices due to its high biocompatibility. Mg has a higher localized or propagation surface plasmon resonance figure of merit than other metals in the UV range, which can allow Mg to out-perform other metals for UV fluorescence enhancements. Despite all of these beneficial properties, some challenges have prevented the use of Mg for bio-sensing. One such challenge is Mg's high corrosion rate in physiological conditions, which can cause Mg to degrade rapidly. Alloying other elements can help tailor Mg's corrosion performance and reduce degradation rates. For example, adding zinc (Zn) introduces intermetallic particles and refines the grain size, which can alleviate corrosion and promote the formation of a passivation film. However, the complex microstructure (e.g. precipitates, twinning, texture, and recrystallization) of Mg alloy can impact its corrosion rate, leading to an uncontrollable corrosion and, consequently, resulting in an unpredictable surface morphology. The enhanced microstructure can include corrosion in the form of increased surface roughness, porosity, corrosion surface patterns, or the like which can vary depending on the specific alloy, corrosion time and conditions, etc.

The surface morphology changes in Mg alloys by corrosion can lead to dramatic changes in bio-sensing performance. For instance, these metallic materials are capable of bio-sensing and enhancing UV spectroscopy performance through localized surface plasmon resonance (SPR), surface-enhanced Raman spectroscopy (SERS), and metal-enhanced fluorescence (MEF). If the surface morphology (e.g., oxide layer, roughness, and residual phases) is changed after corrosion, the UV plasmonic properties of Mg alloy substrate can change as well. The electrochemical corrosion used with the Mg alloy surfaces described herein can increase strengthen advanced imaging and enhance bio-sensing precision by simultaneously avoiding corrosion's negative effects and controlling post-corrosion surface structures. These Mg alloy surfaces can be used in diverse biomedical diagnostics applications with enhanced bio-sensing stability and sensitivity.

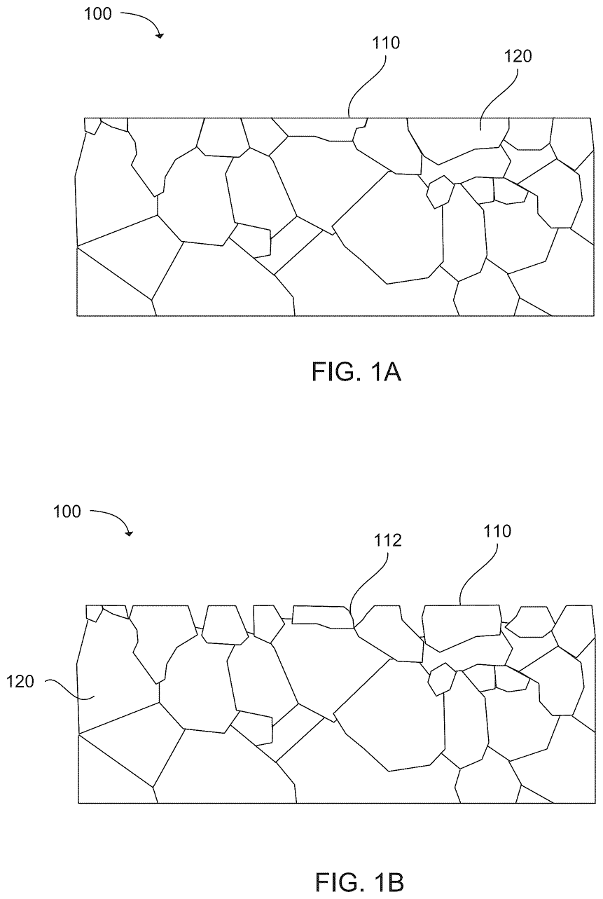

With this general description in mind, FIG. 1A shows a schematic cross-sectional view of a magnesium alloy 100 having a functional surface 110. The magnesium alloy includes grains 120, where individual grains can comprise different phases in the Mg alloy, differing compositions, and/or differing crystal orientations. The grains can have various sizes, as shown in this figure. FIG. 1A shows an example Mg alloy before it is treated with an electrochemical corrosion treatment. FIG. 1B shows the Mg alloy after the electrochemical corrosion treatment. Through the corrosion process, some of the metal is removed from the functional surface, which creates a new microstructure 112 on the surface as shown. In certain examples, grain boundaries can be favorable sites for initiation of the corrosion reaction. Therefore, in this figure the sites where material has been removed through corrosion are at the boundaries between grains (e.g., preferentially secondary phases) on the functional surface. In some other examples, grains can also be corrosively dissolved to form a porous surface structure, which can serve the same sensor purpose.

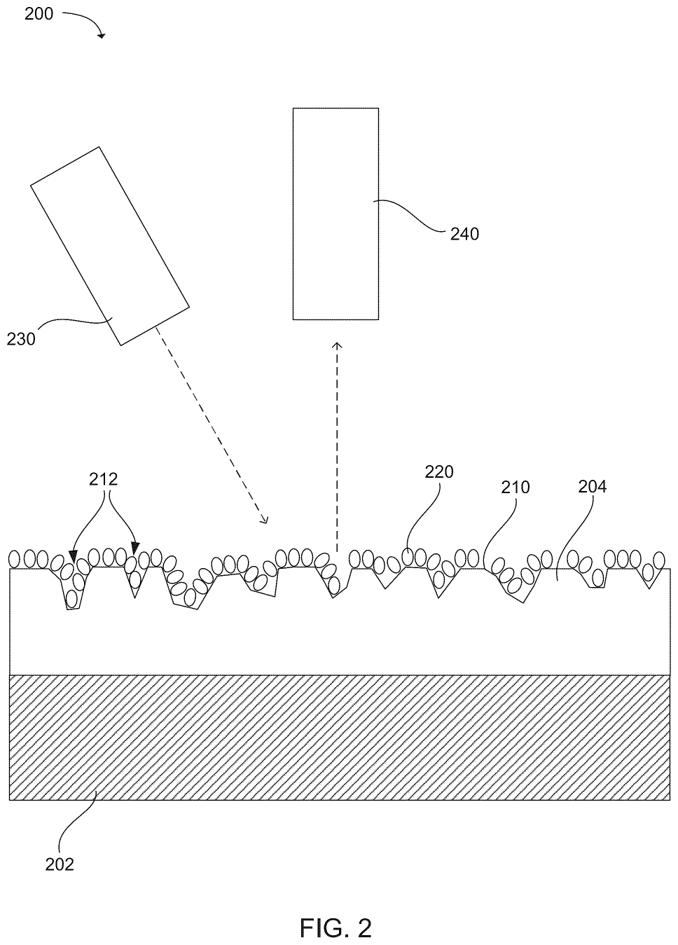

FIG. 2 is a schematic cross-sectional view of an example sensor 200. This sensor includes a sensor substrate 202 with a coating of magnesium alloy 204 supported by the sensor substrate. The Mg alloy coating has a functional surface 210 that has already been treated by electrochemical corrosion to form a fluorescence enhancing microstructure 212. An energy responsive agent 220, such as tryptophan, is coated on the functional surface. An excitation source 230, such as a source of UV light, is positioned to irradiate the sensor surface with exciting radiation. A fluorescence detector 240 is positioned to detect light emitted by the energy responsive agent through fluorescence. The microstructure of the sensor surface has surprisingly been found to increase the signal strength of the fluorescence measured by the fluorescence detector compared to the sensor surface without the electrochemical corrosion treatment.

In some examples, the excitation source can be an ultraviolet (UV) light source. This can be a UV light emitting diode (LED), a UV laser, a black light bulb, or another such UV source. In certain examples, the excitation source can emit a wavelength from about 100 nm to about 400 nm, or from about 200 nm to about 400 nm, or from about 200 nm to about 300 nm, or from about 250 nm to about 300 nm. The fluorescence detector can be a light detector such as a CCD camera, a photodiode, a photoresistor, or others.

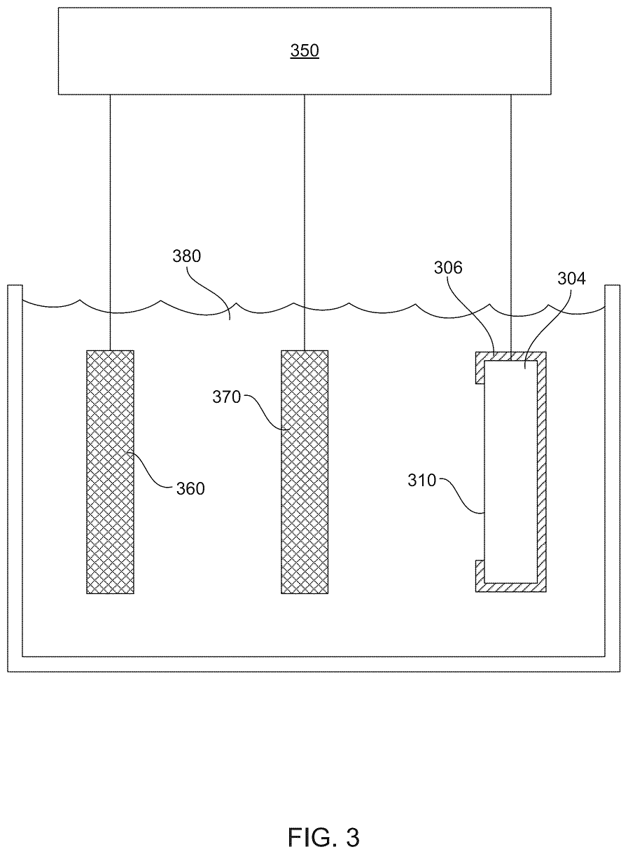

FIG. 3 is a schematic illustration of an example electrochemical corrosion treatment system which can be used to form the corroded surfaces described herein. In this example, a magnesium alloy 304 is encased in resin 306 except for a portion of the surface to be treated. This portion of the surface will be the functional surface 310 of the Mg alloy. The Mg alloy is connected to a potentiostat 350 as a working electrode. A counter electrode 360 and a reference electrode 370 are also connected to the potentiostat. The electrodes are submerged in an electrolyte solution 380. The potentiostat can be used to apply a sufficient voltage to the Mg alloy to drive an electrochemical corrosion reaction, in which a portion of the Mg metal atoms at the functional are dissolved into the electrolyte solution and thus removed from the functional surface.

The corrosion can be performed using electrochemical impedance scanning (EIS). This process can also be used to measure electrochemical properties of the Mg alloy. The electrochemical impedance scanning can be performed using a potentiostat. In some examples, the electrochemical impedance scanning can include measuring an open-circuit potential of the Mg alloy.

In further examples, the electrochemical impedance scanning can include scanning the voltage back and forth at a frequency from about 0.1 Hz to about 100 Hz with a voltage perturbation from about 1 mV to about 1 V at the open-circuit potential. In certain examples, the frequency for this scanning can be from about 0.1 Hz to about 10 Hz, or from about 1 Hz to about 10 Hz, or from about 1 Hz to about 100 Hz, or from about 10 Hz to about 100 Hz.

The electrochemical impedance scanning can also include linear sweep voltammetry. The linear sweep voltammetry can be performed within a voltage range of about +10 mV vs. the open circuit potential. The voltage can be scanned from the minimum voltage to a maximum voltage that is from −20 mV to about +20 mV vs. the open circuit potential.

The electrochemical impedance scanning can also include potentiodynamic polarization from a minimum voltage to a maximum voltage at a scan rate. The minimum voltage for the polarization can be from about −1 V to about −1 mV, or from about −500 mV to about −1 mV, or from about −300 mV to about −1 mV, or from about −300 mV to about-100 mV vs. the open circuit potential. The maximum voltage for the polarization can be from about 1 mV to about 1 V, or from about 1 mV to about 500 mV, or from about 100 mV to about 500 mV vs. the open circuit potential. The scan rate for the polarization can be from about 0.1 mV/s to about 100 mV/s, or from about 0.1 mV/s to about 10 mV/s, or from about 1 mV/s to about 10 mV/s.

In some examples, the electrochemical corrosion treatment can be performed with the Mg alloy connected as a working electrode. A counter electrode and a reference electrode can also be connected with the Mg alloy to a potentiostat as shown in FIG. 3. In alternative examples, the Mg alloy can be connected with a single counter electrode, without a reference electrode. In further examples, the Mg alloy can act as the working electrode and as a reference electrode concurrently, or the counter electrode can act as the reference electrode.

In other examples, the electrochemical corrosion treatment can be performed without a potentiostat. In such examples, the Mg alloy can be submerged in an electrolyte solution with a counter electrode and the Mg alloy and counter electrode can be connected to a voltage source other than a potentiostat. A sufficient voltage can then be applied for a sufficient time to electrochemically corrode the surface of the Mg alloy. The voltage used can be from about 0 V (i.e., free-standing corrosion) to about 1 V vs. open current potential, given the actual used electrolyte. The time for applying the voltage can be from about 10 seconds (for highly corrosion-prone Mg alloys) to about 10 hours (for relatively corrosion-resistant Mg alloys), depending the general corrosion susceptibility.

In various examples, the counter electrode and/or the reference electrode (used with or without a potentiostat) can be made of materials such as graphite or metals such as silver, gold, platinum, copper, titanium, iron, steel, aluminum, or others. In certain examples, multiple counter electrodes and/or multiple reference electrodes may be used, and these electrodes can be made of the same materials or different materials.

The electrolyte solution used during the electrochemical corrosion process can be an aqueous solution comprising dissolved ions that can allow electricity to be conducted through the solution. Some example electrolyte solutions include aqueous sodium chloride solutions, aqueous solutions of potassium permanganate, alkaline solutions such as potassium hydroxide with sodium aluminate, sodium borate, or others, and simulated body fluids. In certain examples, the electrolyte solution can have an ion concentration from about 1% to about 10%, or from about 1 wt % to about 6 wt %, or from about 2 wt % to about 6 wt %, or from about 3 wt % to about 4 wt %. In a particular example, the electrolyte solution can be an aqueous solution of sodium chloride at a concentration from about 3 wt % to about 4 wt %. Simulated body fluids can be solutions that include multiple different compounds that can be present in a body fluid. Some example simulated body fluid compositions include Hanks Balanced Salt Solutions (HBSS), Minimum Essential Medium (MEM), and Earle's Balanced Salt Solutions (EBSS). Table 1 provides the ingredients in several of these simulated body fluid compositions.

TABLE 1

| | HBSS | HBSS | EBSS | MEM | MEM |
|---|---|---|---|---|---|
| Component | (H1387) | (14175) | (E7510) | (M9288) | (M0268) |
| Cl⁻ (mM) | 145 | 143 | 125 | 145 | 125 |
| HCO₃⁻ | 4.2 | 4.2 | 26 | 4.2 | 26 |
| (mM) | | | | | |
| H₂PO₄⁻ | 0.44 | 0.44 | 1.02 | 0.44 | 1.02 |
| (mM) | | | | | |
| HPO₄²⁻ | 0.34 | 0.34 | — | 0.34 | — |
| (mM) | | | | | |
| SO₄²- (mM) | 0.81 | — | 0.81 | 0.81 | 0.81 |
| Mg²⁺ (mM) | 0.81 | — | 0.81 | 0.81 | 0.81 |
| Ca²⁺ (mM) | 1.26 | — | 1.80 | 1.26 | 1.36 |
| Na⁺ (mM) | 142 | 143 | 144 | 142 | 143 |
| K⁺ (mM) | 5.81 | 5.81 | 5.37 | 5.81 | 5.37 |
| Amino | — | — | — | 0.87 | 0.87 |
| Acids (g/L) | | | | | |
| Vitamins | — | — | — | 0.008 | 0.008 |
| (g/L) | | | | | |
| Glucose | 1.0 | 1.0 | 1.0 | 1.0 | 1.0 |
| (g/L) | | | | | |

It is noted that phosphate buffered saline (PBS) is not considered to be a simulated body fluid as it is not sufficiently comparable to body fluids. However, in some examples the electrolyte solution used for the electrochemical corrosion treatment can include phosphate buffered saline.

Electrochemical corrosion of magnesium can follow the overall corrosion reaction of equation 1:

Mg+2H₂O→Mg(OH)₂+H₂ (1)

Thus, magnesium metal at the surface of the Mg alloy can be removed from the surface and converted to magnesium hydroxide, while hydrogen gas is evolved. In some cases an oxide layer can also be formed on the surface of the Mg alloy. In certain examples, an alkaline electrolyte solution can be used, and the electrochemical corrosion treatment can form a passivation film (i.e. having a composition of mainly Mg(OH)₂ and MgO and others like magnesium phosphate, etc., depending on the electrolyte chosen, the film can usually form with a thickness at the order of ˜1 micrometer) on the surface.

The electrochemical corrosion treatment can increase the surface roughness of the Mg alloy. In some examples, the surface roughness can be increased by 10% to 500%, or by 10% to 200%, or by 10% to 100%, or by 10% to 50%, or by 50% to 200%, or by 50% to 100%. The surface roughness can be measured using confocal microscopy or by scanning electron microscopy in some cases. In certain examples, the Mg alloy (after the electrochemical corrosion treatment) can have a surface roughness Sa (defined as a mean difference in height from a mean plane of the functional surface) that is from about 5 micrometers to about 20 micrometers, or from about 5 micrometers to about 15 micrometers, or from about 10 micrometers to about 20 micrometers. The surface roughness can also be expressed as Sq, defined as the root mean square height and is equivalent to the standard deviation of the height distribution. In some examples, the surface roughness Sq can be from about 6 micrometers to about 24 micrometers. In one example, the sample surface before corrosion can be polished (e.g. 800 grit). In some cases, a larger initial surface roughness will directly introduce damage like cracks, etc., to degrade the sensor unit locally before usage such that polishing can help mitigate or prevent such cracks or similar damage. As a general guideline, the current and voltage range for corrosion can be set to a mild point such that the corrosion will not deform, smash, or destroy the sensor alloy directly. Thus, in some cases, the surface treatment temperature can be near the water boiling temperature.

The Mg alloy can include high angle grain boundaries (HAGBs) having a misorientation greater than 15 degrees. The misorientation refers to a difference in angle between the crystal orientation of two adjacent grains. High angle grain boundaries can provide a favorable location for initiation of the corrosion reaction. Therefore, magnesium metal can be preferentially removed at the high angle grain boundaries. The microstructure of the corroded surface can be affected by the fraction of high angle grain boundaries vs. low angle grain boundaries, and the size of the grains having high angle grain boundaries. In some examples, the high angle grain boundaries of the Mg alloy can make up from 50% to 100% of the total grain boundaries in the Mg alloy. In further examples, the high angle grain boundaries can make up from 50% to 90%, or 50% to 80%, or 50% to 70%, or 70% to 90%, or 80% to 90% of the total grain boundaries in the Mg alloy. The number of high angle grain boundaries and grain size can be affected by the types of alloying elements in the Mg alloy and the amounts of the alloying elements in the alloy, along with other factors such as thermal and mechanical treatments that can be performed on the alloy.

The Mg alloy can include magnesium and at least one alloying element. In various examples, the Mg alloy can comprise at least 50% magnesium by volume. In further examples, the Mg alloy can comprise at least 75%, or at least 80%, or at least 85%, or at least 90%, or at least 95% magnesium by volume. The alloying element can comprise at least one of the following elements: aluminum, lithium, calcium, zinc, silicon, silver, a rare earth metal such as lanthanum, cerium, praseodymium, neodymium, promethium, samarium, europium, gadolinium, terbium, dysprosium, holmium, erbium, thulium, ytterbium, lutetium, scandium, or yttrium, or a transition metal such as zirconium, molybdenum, or strontium. Some non-limiting examples of magnesium alloys that can be used include: Mg—Al, Mg—Li, Mg—Ca, Mg—Zn, Mg—Si, Mg—Ag, and Mg—X where X is a transition metal or rare earth metal, and combinations of these. In certain examples, the Mg alloy can be AZ31B alloy, Mg—4Li—Ca alloy, or Mg—Zr—Sr alloy. In another example, Al matrix alloys with high Mg content and other balanced elements such as, but not limited to, Cu, Ti, and other inert elements can also be used, especially when the surface is corrosion-processed to have porous patterns on the resultant rough surfaces.

The Mg alloy functional surface can be coated with an energy responsive agent. As used herein, “coated” can mean covered fully with a uniform coating, covered fully with a non-uniform coating, or covered partially. In some examples, the coating of the energy responsive agent can have a coating thickness from about 1 nm to about 20 μm, depending on the type of energy response agent. In particular examples, the coating thickness can be from 1 nm to 10 μm, and in some cases 1 nm to 1 μm. In certain examples, the energy responsive agent can be a molecular compound, and the coating on the functional surface can have a thickness of one molecule. The molecules of the energy responsive agent can be attached to the functional surface by covalent bonding in some cases, or the molecules can be held to the surface by other forces such as dipole forces, hydrogen bonding, Van der Waals forces, electrostatic forces. In other examples, the energy responsive agent can be unattached and simply can rest on the surface of the Mg alloy. Other examples of molecular energy responsive agents can include proteins, nucleic acids, tryptophan, tyrosine, phenylalanine, and other fluorescent molecules.

In some examples, the energy responsive agent can be a target analyte, and the sensor can be used to detect the presence of the energy responsive agent. For example, a sensor can be used to detect the presence of tryptophan. If tryptophan is present, the tryptophan can form a coating on the surface of the Mg alloy, and fluorescence from the tryptophan can be detected to indicate its presence. Such a sensor can be used to measure the concentration of the target analyte because a low concentration of the target analyte can form a sparse coating on the Mg alloy surface, whereas a high concentration can form a more continuous coating. When fluorescence of the target analyte is measured, the more continuous coating can display a stronger fluorescence signal than the sparse coating.

In certain examples, the sensor can be used to detect microplastics or nanoplastics. In such examples, the target analyte can be microplastic or nanoplastic particles. These can include polymer particles with an average particle diameter of less than 1,000 nm (for nanoplastics) or polymer particles with an average particle diameter of less than 1,000 micrometers (for microplastics). The microplastics or nanoplastics can be responsive to radiation by fluorescing, and the sensor can allow the presence of these particles to be detected by detecting their fluorescence.

In further examples, the energy responsive agent can be an agent that produces a fluorescence signal when a different target analyte is present. Such an energy responsive agent can include ligands, antigens, antibodies, other molecules that may selectively interact with certain target analytes, and so forth. In certain examples, the sensor surface can be coated with a coating of such an agent and then the sensor can be used to detect the presence of another target analyte that interacts with the energy responsive agent.

The electrochemically corroded surface of the Mg alloy can provide an enhanced fluorescence signal compared to the same Mg alloy without the electrochemical corrosion treatment. In some examples, the fluorescence signal of an energy responsive agent on the corroded surface can be from about 50% to about 1,000% greater than the fluorescence signal detectable with the same energy responsive agent on an uncorroded Mg alloy surface. In further examples, the fluorescence signal can be increased by 50% to 500%, or by 50% to 300%, or by 50% to 200%, or by 50% to 100%.

In certain examples, the sensor described herein can be at least partially biodegradable. This can be useful for sensors that are intended to be used temporarily in nature before degrading, or for implantable sensors that are intended to be used temporarily in the body before degrading. As mentioned above, magnesium can have good biodegradability properties. Magnesium sensor surfaces would normally degrade too quickly or at an unpredictable degradation rate. However, the electrochemical corrosion treatments described herein can modify the surface of a magnesium alloy so that the degradation rate is slower and more predictable. However, the sensor can still be designed to degrade after a desired time period. In some examples, the sensor can degrade in an in vivo environment after a time period from 2 days to 6 months, or from 7 days to 6 months, or from 1 month to 6 months, or from 2 days to 1 month, or from 2 days to 7 days. As used herein, a sensor can be considered to have “degraded” if the signal detected at a given concentration of a target analyte is reduced to less than about 20% of the original signal that was produced by the same concentration of the target analyte when the sensor was new.

In another example, the sensor can be used in surface enhanced Raman scattering, electrochemical sensors, and the like.

### EXAMPLES

### Example 1

In this example, corrosion is used to simultaneously stabilize a Mg alloy surface and enhance its tryptophan bio-sensing sensitivity within a reasonable time period. Commercially available AZ31B alloy (with Al as its main alloying element) was used as the substrate to study the effect of corrosion-induced surface roughness on the tryptophan signal enhancement of Mg alloy. The corroded surface and the electrochemical properties of AZ31B were obtained using electrochemical impedance scanning (EIS), and the surface roughness of the intact and corroded samples were measured using confocal microscopy. Both intact and corroded samples were coated with tryptophan, and their signal enhancement capabilities were analyzed and compared.

AZ31B was purchased from Metal Mart and selected as the substrate material in this study because of its promising biodegradability. The detailed composition of the purchased AZ31B is listed in Table 2:

TABLE 2

| Element | Amount (wt %) |
|---|---|
| Al | 2.5-3.5 |
| Zn | 0.6-1.4 |
| Mn | 0.2 |
| Si | 0.1 |
| Cu | 0.05 |
| Ca | 0.04 |
| Fe | 0.005 |
| Ni | 0.005 |
| Mg | Balance |

L-tryptophan (>98%) and polyvinyl alcohol (PVA, MW 13000-23000) were purchased from Sigma-Aldrich Co.

The surface morphology and the microstructure of AZ31B were analyzed by electron microscopy (SEM) and energy dispersion scanning (EDS) on FEI Quanta 600F with the acceleration voltage of 20 kV and spot size of 5.5. The electron backscatter diffraction (EBSD) data was captured on an FEI Teneo SEM to obtain grain size, morphology, and grain boundary misorientation distribution of the AZ31B substrate with an acceleration voltage of 20 kV and current of 50 nA.

To analyze the electrochemical properties of AZ31B and obtain a rough surface in a controllable and predicable way, electrochemical impedance scanning (EIS) was conducted on VersaSTAT 4 using following procedure: First, measurement of open-circuit potential (OCP) for 600 s stabilization was conducted. Second, a back-and-forth potentiostatic scan was done within the frequency range of 0.1 Hz to 100 Hz with a voltage perturbation of 10 mV at OCP. Third, linear scan voltammetry was added between −20 mV to 20 mV vs. OCP. Finally, a potentiodynamic polarization from −0.25 V to 0.4 V vs. OCP with a scan rate of 1 mV/s was applied. One Ag/AgCl reference electrode and two graphite counter electrodes were used. The samples were sealed in epoxy resin with an exposed area of ˜0.50 cm². All the EIS measurements were conducted in 3.5 wt. % NaCl solution at ambient temperature. The surface roughness of the AZ31B substrate before and after EIS process, as well as after tryptophan coating, were measured and compared by Olympus Lext O1s5000 laser confocal microscope.

To evaluate the assay capability of the desired AZ31B substrate as a transient biosensor, fluorescence measurements were conducted after spin coating of tryptophan molecules on both intact and after EIS samples. Tryptophan was dissolved in 0.25 wt % PVA aqueous solution to the concentration of 1 mM and then spin-coated for 30 sec at 3000 rpm on the surface of the substrates. A thin Au layer with the thickness of 10 nm was applied on the tryptophan coated surface by a Leica Em Ace600 sputter coater to correctly obtain the surface roughness of the transparent tryptophan coating.

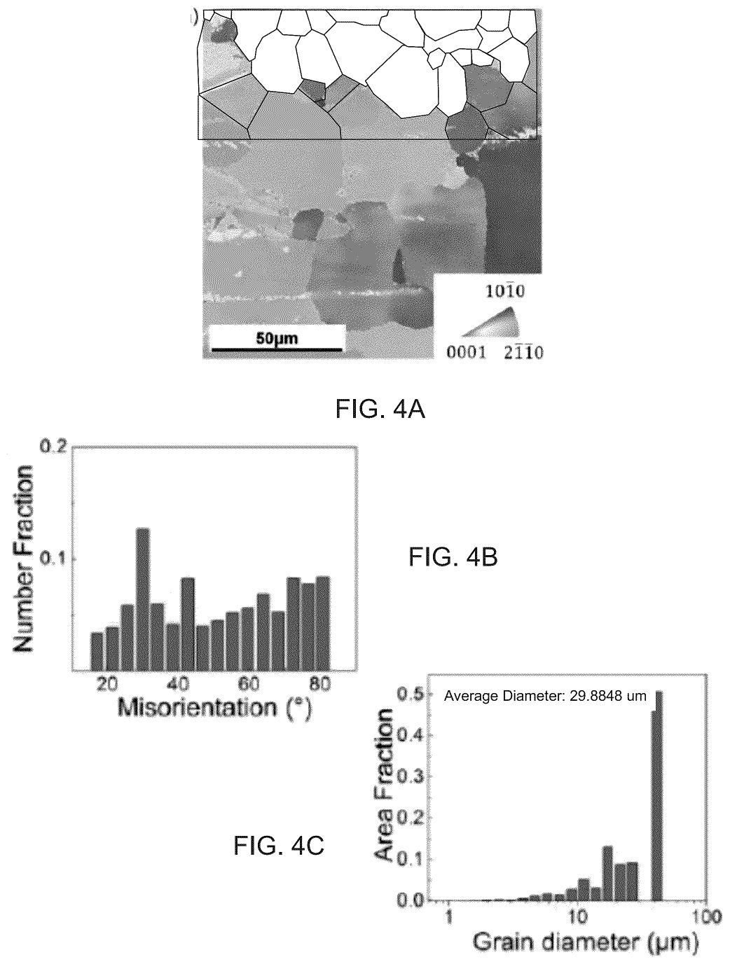

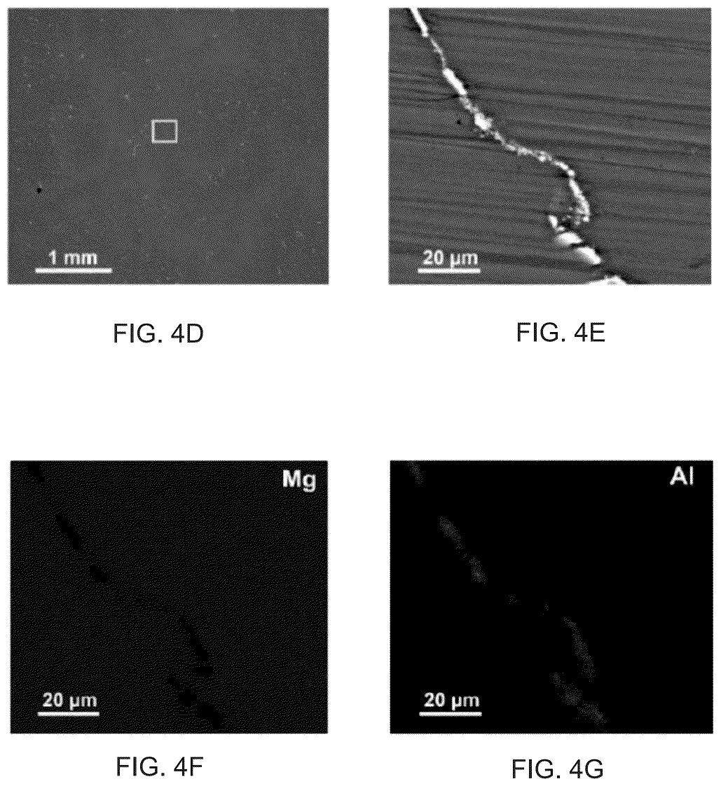

High-angle grain boundaries (HAGBs) are an ideal site for the initiation of localized corrosion, while the finer grain size is benefit for the formation of passivation film, which can improve the corrosion resistance of AZ31B alloy. The EBSD results shown in FIGS. 4A-4C indicate a high presence of HAGBs and an average grain size of ˜30 μm. According to the Mg—Al phase diagram, β—Mg₁₇Al₁₂ is the main intermetallic phase in AZ31B, and the interface between α-Mg and β—Mg₁₇Al₁₂ is the most susceptible site for corrosion attack due to micro galvanic coupling attack. The distribution and morphology of the intermetallic phase in AZ31B were analyzed by back scattered SEM and EDS as shown in FIGS. 4D-4G. The intermetallic phase of AZ31B is concentrated along the grain boundary (GB) discontinuously, and the EDS results show that the main component is Al, indicating the presence of β—Mg₁₇Al₁₂.

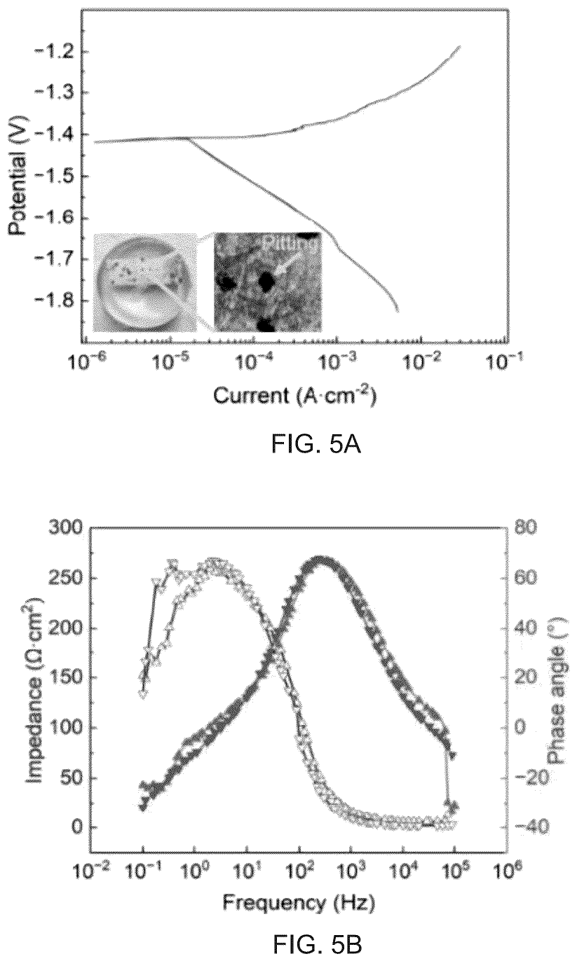

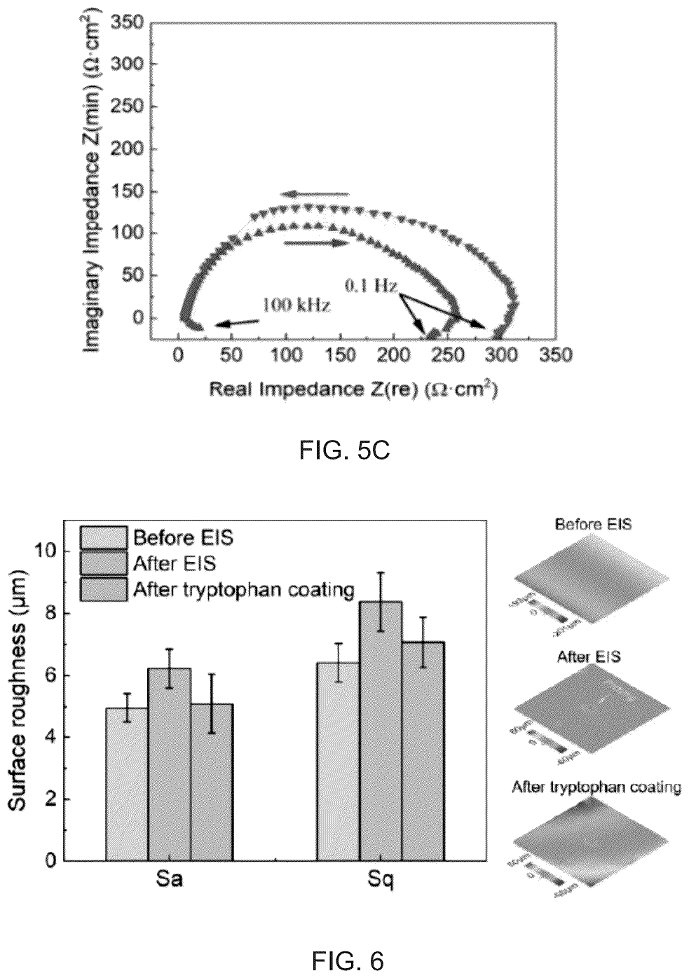

The dual role of EIS is to both measure the corrosion resistance of AZ31B and introduce controllable surface morphology. The overall corrosion reaction of AZ31B in NaCl solution can be described by Equation (1) above. FIG. 5A shows the polarization curve of AZ31B, where the anodic reaction is Mg dissolution and the cathodic reaction is controlled by hydrogen evolution reaction. Note that there is no obvious passivation film breakdown in anodic side. This is because the large grain size prevents the formation of passivation film, leading to a high corrosion rate of AZ31B. The corrosion potential (Ecorr) of the AZ31B alloy was-1.41 V. The corrosion current density (Icorr) was 17.12 μA·cm⁻². The polarization resistance (Rp) was 177.03 Ω·cm². The corrosion rate can be calculated using Equation (2) according to ASTM G59:

$$R = 3.27 \times {10}^{- 3 \frac{{i}_{c o r r} E W}{ρ}} \qquad ( 2 )$$

where CR (mm/year) is the corrosion rate, EW (g) is the equivalent weight, and ρ (g/cm³) is the density of AZ31B. The calculated corrosion rate of AZ31B is 0.391 mm/year.

The arithmetical mean height (Sa) and root mean square height (Sq) of AZ31B was measured to evaluate the surface roughness before EIS process, after EIS process, and after tryptophan coating. The results are summarized and compared in FIG. 6. The results show that the surface roughness of AZ31B increased after the EIS, and decreased after coating a thin layer of tryptophan but still higher than the sample before EIS. The visual sample analysis in FIG. 5A also confirms the changed surface roughness by the EIS measurement and corrosion process.

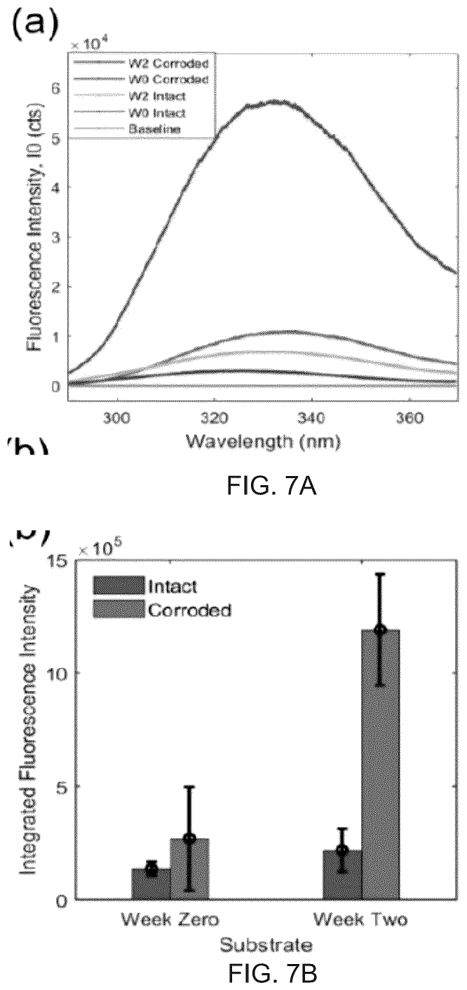

After spin-coating of Tryptophan onto both the corroded and intact samples, fluorescence measurements were conducted under UV irradiation. Data was collected for two series of substrates, corresponding to the initial measurements (denoted as week zero/W0), and after oxidation measurements, which were performed two weeks after preparing the substrates (denoted as week 2/W2), as illustrated in FIG. 7A.

Upon exposure to the 266 nm UV laser (10 mW), the native fluorescence from Tryptophan molecules was excited and collected by a collector lens and a CCD camera. Depicted in FIG. 7A is the fluorescence intensity from Tryptophan molecules coated on different substrates at different times. The emission peaks are detected in the ranges of 321-325 nm, because tryptophan is immobilized on the surface and immersed in PVA instead of water. Additionally, the term “Baseline” pertains to the measurement conducted prior to applying tryptophan spin-coating. This is done to verify that fluorescence signals solely result from the presence of the tryptophan molecules.

From the average fluorescence decay series of 5 reproducible spots, integrated fluorescence intensity per excitation cycle has been calculated. FIG. 7B shows the integrated fluorescence intensity of tryptophan on both substrates at different times. In order to make a comparative analysis between the integrated values of the fluorescence intensity from different substrates, an enhancement factor was calculated by dividing and normalizing these integrated values for different scenarios. The oxidized corroded substrate showed the highest enhancement among other condition. For the initial samples, a 1.97-fold enhancement ratio of corroded to intact samples was observed in Week Zero (Corroded-W0/Intact-W0), and this ratio increased to 5.45 times for the Week Two (Corroded-W2/Intact-W0). Also, the enhancement ratio for the second week to the zeroth week of the corroded samples was 4.42 (Corroded-W2/Corroded-W0), while this rate was 1.59 for the Intact sample comparison (Intact-W2/Intact-W0).

This approach allows enhancing the fluorescence signal of tryptophan using Mg alloy substrate with corrosion modified surface morphology. The microstructure and electrochemical properties of the AZ31B were analyzed. The surface roughness measurements reveal that the EIS process can significantly increase the surface roughness of the Mg alloy, which is beneficial for the fluorescence signal strengthening. The fluorescence signal measurements demonstrate that corrosion on Mg alloy surfaces can enhance the emitted fluorescence signals from molecules by 5.45 times, even after 2 weeks. Consequently, under UV illumination, these substrates can serve as a rapid, cost-effective, direct, and label-free detection method for various fluorophore biomolecules, proteins, or peptide-based structures.

### Example 2

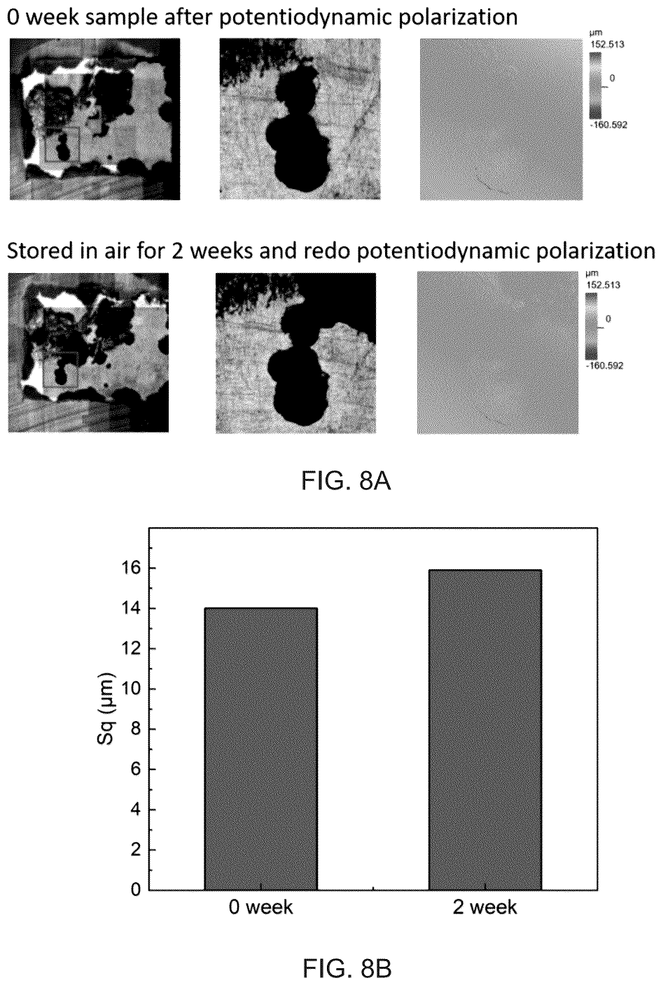

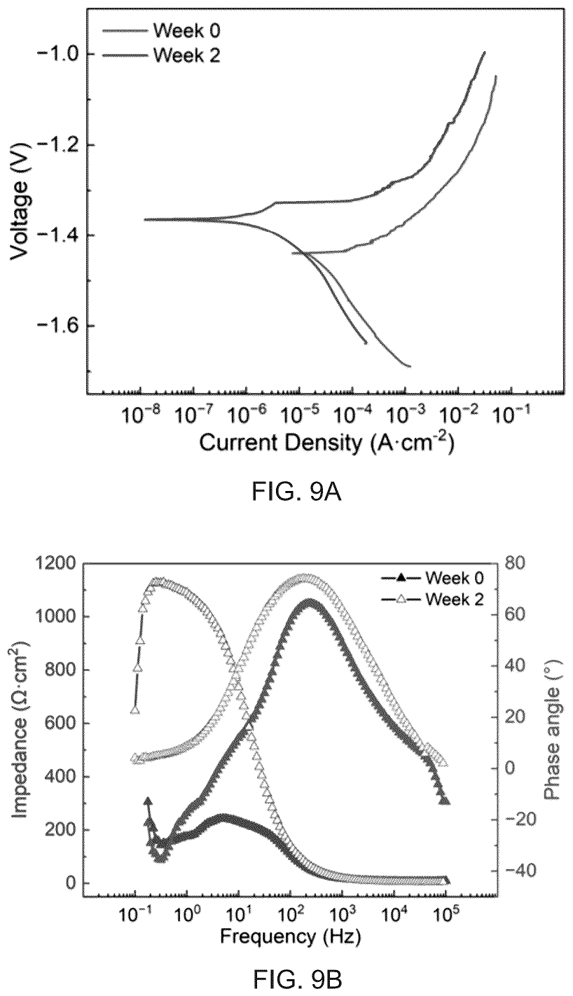

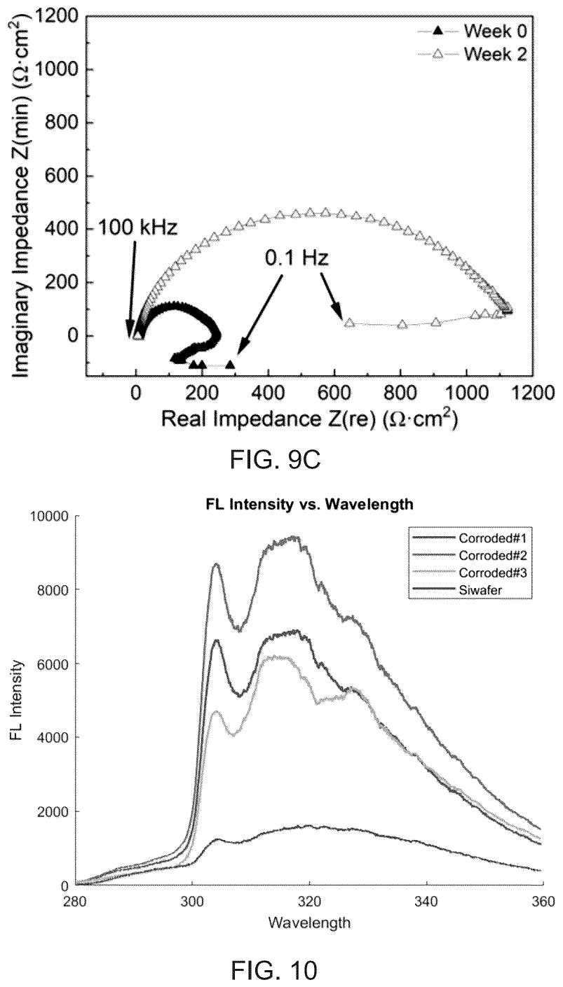

Another magnesium alloy substrate was treated using EIS as described in Example 1. FIG. 8A shows photographs and surface height of the surface 0 weeks after the EIS treatment, and 2 weeks after the EIS treatment. The surface roughness Sq was measured at week 0 and week 2. FIG. 8B is a graph showing the Sq surface roughness at week 0 and week 2. The surface roughness increased slightly after two weeks. EIS measurements were taken at week 0 and at week 2. The results of these measurements are shown in FIGS. 9A-9C. The electrochemical measurement parameters at week 0 and week 2 are given in Table 3:

TABLE 3

| | Rₛ (Ω · cm²) | R₁ (Ω · cm²) | Q₁ (Ω · cm² · sⁿ) | n₁ |
|---|---|---|---|---|
| Week 0 | 10.56 | 297.3 | 17.264 | 0.926 |
| Week 2 | 6.86 | 1384.0 | 17.770 | 0.892 |

The fitted electrochemical impedance parameters are given in Table 4:

TABLE 4

| | E_{corr} (V) | I_{corr} (μA · cm²) | Eₚᵢₜ (V) | Rₚ (Ω · cm²) | R² for Rₚ |
|---|---|---|---|---|---|
| Week 0 | −1.441 | 22.677 | — | 214.100 | 0.993 |
| Week 2 | −1.364 | 0.254 | 0.037 | 8565.196 | 0.974 |

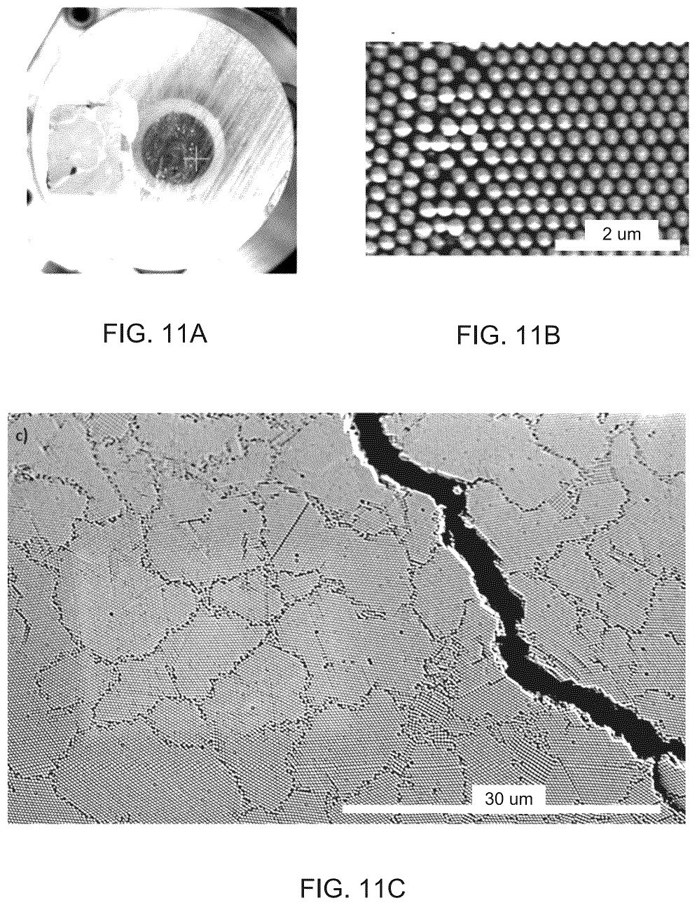

The substrate was then coated with polystyrene nanobeads. Three example corroded surfaces with polystyrene beads were then exposed to UV light and fluorescence was measured. A normal silicon substrate was also coated with polystyrene nanobeads and measured for comparison. FIG. 10 is a graph of fluorescence intensity of the corroded magnesium alloy substrates coated with polystyrene nanobeads compared to the silicon substrate coated with polystyrene nanobeads. FIG. 11A shows a photograph of the corroded magnesium substrate with polystyrene beads. FIGS. 11B and 11C are SEM images showing the monolayer of polystyrene nanobeads on the surface.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A sensor comprising a functional surface comprising a magnesium alloy, wherein the functional surface has a fluorescence enhancing microstructure formed by electrochemical corrosion of the magnesium alloy at the functional surface.

2. The sensor of claim 1, wherein the fluorescence enhancing microstructure comprises a surface roughness increased by the electrochemical corrosion compared to the functional surface prior to the electrochemical corrosion.

3. The sensor of claim 2, wherein the surface roughness is from 5 micrometers to 20 micrometers, wherein the surface roughness is Sa, defined as a mean difference in height from a mean plane of the functional surface.

4. The sensor of claim 2, wherein the surface roughness is from 10% to 500% greater than a surface roughness of the functional surface prior to the electrochemical corrosion.

5. The sensor of claim 1, wherein the magnesium alloy comprises high angle grain boundaries (HAGBs) having a misorientation greater than 15 degrees.

6. The sensor of claim 5, wherein the HAGBs comprise a number fraction of total grain boundaries of the magnesium alloy that is from 50% to 100%.

7. The sensor of claim 1, wherein the magnesium alloy is at least 50% by volume magnesium.

8. The sensor of claim 1, wherein the magnesium alloy includes at least one of aluminum, lithium, calcium, zinc, silicon, silver, a rare earth metal, and a transition metal.

9. The sensor of claim 1, wherein the magnesium alloy is selected from the group consisting of: Mg—Al, Mg—Li, Mg—Ca, Mg—Zn, Mg—Si, Mg—Ag, Mg—X wherein X is a transition metal or rare earth metal, and combinations thereof.

10. The sensor of claim 9, wherein the magnesium alloy is AZ31B, Mg—4Li—Ca, or Mg—Zr—Sr.

11. The sensor of claim 1, further comprising an energy responsive agent at least partially coated on the functional surface.

12. The sensor of claim 11, wherein the energy responsive agent is a fluorescence responsive agent which is at least one of tryptophan, tyrosine, phenylalanine, a nanoplastic, or a microplastic.

13. The sensor of claim 12, wherein a fluorescence signal from the energy responsive agent is increased by the fluorescence enhancing microstructure compared to the same energy responsive agent on an uncorroded surface of the magnesium alloy.

14. The sensor of claim 13, wherein the fluorescence signal is increased by 50% to 1,000%.

15. The sensor of claim 11, wherein the energy responsive agent forms a coating with a thickness from 1 nm to 10 μm.

16. The sensor of claim 1, further comprising a sensor substrate, wherein the magnesium alloy is a coating supported by the sensor substrate.

17. The sensor of claim 1, wherein the magnesium alloy is self-supporting without a separate supporting substrate.

18. The sensor of claim 1, wherein the sensor degrades in vivo after a time period from 2 days to 6 months.

19. A method of forming a sensor, comprising:
providing a precursor substrate having a magnesium alloy surface; and
electrochemically treating the magnesium alloy surface in the presence of an electrolyte to electrochemically corrode the surface.

20. The method of claim 19, wherein the electrolyte is selected from the group consisting of NaCl (e.g. 3.5 wt %), simulated body fluids, KMnO₄, and alkaline solutions.

21. The method of claim 19, wherein the electrolyte is an alkaline solution and the surface further includes a passivation film.

22. The method of claim 19, wherein the electrochemical treatment is performed for a sufficient time to increase a surface roughness of the magnesium alloy surface by 10% to 500%.
